(19) United States
(12) Patent Application Publication
(10) Pub. No.: US 2014/0311796 A1
(43) Pub. Date: Oct. 23, 2014

(54) WIRE HARNESS FOR HIGH TEMPERATURE EXHAUST GAS APPLICATIONS

(71) Applicant: HARCO LABORATORIES, INC., Branford, CT (US)

(72) Inventors: Robert C. Gannon, Branford, CT (US); John M. Champagne, Branford, CT (US); Igor Giterman, Woodbridge, CT (US)

(73) Assignee: Harco Laboratories, Inc., Branford, CT (US)

(21) Appl. No.: 13/864,878

(22) Filed: Apr. 17, 2013

(51) Int. Cl. H01B 7/00; H01B 13/012

(52) U.S. Cl. CPC H01B 7/0045; H01B 13/012
USPC 174/72 A; 29/825

(57) ABSTRACT

A wire harness and method for manufacturing thereof are provided. The wire harness includes a plurality of wires, a terminal member, an inverted sleeve, and a high temperature moisture resistant sealant. The plurality of wires includes one or more wires with protective layers of metal and fiberglass and skived Teflon tape as a moisture barrier where at least one end of the wires with protective layers of metal and fiberglass is connected with a terminal member. Protection from moisture is enhanced by enclosing at least one end of the wires with protective layers of metal glass with the inverted sleeve. The inverted sleeve provided has ends where each end has a fold, thereby preventing frayed edges from being exposed to the sleeve's surrounding environment. The inverted sleeve is coated with a high temperature moisture resistant sealant and encloses junctions between wire ends and terminal members and/or junctions between terminal members.

### FIELD OF THE INVENTION

The invention relates to a wiring harness and a method for manufacturing the same, and particularly, to a wire harness including a wire with protective layers of metal and fiberglass for high temperature exhaust gas applications.

### BACKGROUND OF THE INVENTION

A variety of control components such as engine monitoring sensors are used in modern turbine engines. The engine monitoring sensors are typically electrically connected to an electronic control unit by a wiring harness. A wire harness includes a plurality of wires that are bundled to form a main trunk and a plurality of branches extending from the trunk where at least one end of the wires is connected to a terminal connected to a sensor unit.

A turbine engine is generally operated in a potentially detrimental environment in which moisture is present. Moisture infiltrating through a wire harness, particularly through connections between the wires and the terminals, may pass from the engine to the interior and can cause incorrect indications during aircraft operations such as engine starts, ground taxi, takeoff, ascending, cruise, descending, landing, shutoff, maintenance, and aircraft operations that may encounter ground static. Thus, it is desirable to protect a wire harness from moisture penetration, thereby preventing any incorrect indications from occurring during aircraft operations.

Wiring systems have been developed to provide moisture protection for wire harnesses. One type of wiring utilizes a hermetically sealed tube. In particular, an electrical wire is enclosed by a metal tube hermetically sealed by welding or brazing. Another type of wiring involves covering a wire with protective layers of metal and fiberglass, which is often used for V2500 and other engines. One advantage of the wiring with hermetic sealing is that it provides good protection against moisture, moisture being generally defined herein to include water, fuel, deicing fluids, cleaning fluids, salt water, humidity and the like, but it is bulky, expensive, and difficult to install and maintain. To the contrary, the wiring utilizing protective layers of metal and fiberglass is less expensive and its installation and maintenance are relatively easy. However, the protective layers of the wire are sometimes porous and thus do not provide a desired level of protection against moisture.

In addition to moisture penetration through a wire, a junction between a wire end and a terminal member such as a terminal lug is another source for moisture infiltration because the junction is generally not covered by the protective layers of the wire and becomes exposed to its surrounding environment. One way to prevent moisture infiltration at a wire end junction is to enclose the junction with a sleeve. A sleeve for a wire end is generally manufactured by cutting a tube of thermoplastics or other materials in a desired size where the cut off ends of the sleeve have frayed edges. When a sleeve is made of a porous material, even if a wire end junction is enclosed with the sleeve, moisture can penetrate through the sleeve's wall as well as the sleeve's ends having frayed edges that exacerbate the moisture penetration.

There is a need for a wire harness which is cost effective and provides good environmental protection without compromising its ease of installation and maintenance. However, the conventional wire harness designs have not provided an adequate solution to satisfy such needs.

### BRIEF SUMMARY OF THE INVENTION

The foregoing needs are met, to a great extent, by the invention, wherein in one aspect, there is provided a cost effective wiring harness utilizing a wire with protective layers of metal and fiberglass and skived Teflon tape as a moisture barrier, in which environmental sealing is applied to the wire harness, thereby providing environmental and electrical insulation particularly for high temperature exhaust gas applications without compromising the ease of installation and maintenance.

A conventional wire with protective layers of metal and fiberglass is provided with a plurality of fiberglass braids and thermal insulation layers. However, although the wire with protective layers of metal and fiberglass provides many advantages such as easy installation, maintenance and low cost, the protective layers are sometimes porous and they do not provide good protection against moisture compared to a hermetically sealed wire. To the contrary, the hermetically sealed wire is expensive and not easy to install and maintain. Recognizing the lack of good protection against moisture in a wire with protective layers of metal and fiberglass, the inventors have discovered that the lack of protection against moisture can be overcome in a wire harness by combining a wire with certain protective layers of metal and fiberglass and skived Teflon tape as a moisture barrier, with an inverted sleeve and a high temperature moisture resistant sealant without compromising the advantages that a wire with protective layers of metal and fiberglass generally provides.

In one aspect of the invention there is provided a wire harness having a wire with protective layers of metal and fiberglass and skived Teflon tape as a moisture barrier, a terminal member, an inverted sleeve and a high temperature moisture resistant sealant. According to the invention, the wire harness includes a plurality of wires including a wire with protective layers of metal and fiberglass at least one end of which is connected with a terminal member. Optionally, every wire end in the harness is connected with a terminal member. The wire with protective layers of metal and fiberglass often has a porous surface that is susceptible to moisture penetration. In order to obtain good protection against moisture, the protective layers of metal and fiberglass may include skived Teflon tape as a moisture barrier. The protection from moisture is further enhanced by enclosing at least one end of the wires with protective layers of metal and fiberglass with a sleeve. In some aspects, the sleeve may include an inverted sleeve. The inverted sleeve encloses a junction between at least one of the wires with protective layers of metal and fiberglass and a terminal member. The inverted sleeve provided has ends which do not have frayed edges that are known to wick up moisture. Optionally, the inverted sleeve may have ends each of which has a fold, thereby preventing the frayed edges from being exposed to the sleeve's surrounding environment. In addition to such structural protection from moisture that the inverted sleeve provides, the inverted sleeve may include a high temperature moisture resistant sealant. In some aspects, the inverted sleeve may be coated with a high temperature moisture resistant sealant. Optionally, the inverted sleeve may include one or more folded sleeves where the folded sleeves are coated with the high temperature moisture resistant sealant.

Another aspect of the invention discloses a method for manufacturing a wire harness, the method including forming a main trunk including a plurality of wires that includes one or more wires with protective layers of metal and fiberglass and skived Teflon tape as a moisture barrier; connecting a wire end of the one or more wires with protective layers of metal and fiberglass with a terminal member; applying a high temperature moisture resistant sealant to an inverted sleeve; and enclosing a junction between the wire end and the terminal member with the inverted sleeve.

Still yet another aspect of the invention discloses a method for manufacturing a wire harness, the method including forming a main trunk including a plurality of wires that include one or more wires with protective layers of metal and fiberglass and skived Teflon tape as a moisture barrier; connecting a wire end of the one or more wires with protective layers of metal and fiberglass with a terminal member; folding ends having frayed edges of a sleeve to form an inverted sleeve; soaking and wetting the inverted sleeve in the high temperature moisture resistant sealant prior to being placed over the wire end; placing the wet sleeve over the wire end to enclose a junction between the wire end and the terminal member; optionally bending the wet sleeve to be firmly held at a desired location; and subsequently curing the wire end and the inverted sleeve.

Still yet another aspect of the invention discloses an engine system comprising the wire harness according to the invention discussed above where the wire harness includes a wire with protective layers of metal and fiberglass and skived Teflon tape as a moisture barrier, a terminal member, an inverted sleeve and a high temperature moisture resistant sealant.

Still yet another aspect of the invention discloses an engine system comprising a terminal and the wire harness according to the invention where the wire harness includes a wire with protective layers of metal and fiberglass and skived Teflon tape as a moisture barrier, a terminal member, an inverted sleeve and a high temperature moisture resistant sealant and where the high temperature moisture resistant sealant is further applied to the terminal (stud) which is to be electrically connected to a wire in the harness.

As described above, in the invention, one wire harness is formed by employing one or more wires with protective layers of metal and fiberglass and skived Teflon tape as a moisture barrier, an inverted sleeve, a high temperature moisture resistant sealant. In view of the invention, it is possible to provide a wire harness containing a wire with protective layers of metal and fiberglass and skived Teflon tape as a moisture barrier, which has excellent moisture protection without compromising all the advantages that a wire with protective layers of metal and fiberglass provides.

There has thus been outlined, rather broadly, certain aspects of the invention in order that the detailed description thereof herein may be better understood, and in order that the present contribution to the art may be better appreciated. There are, of course, additional aspects of the invention that will be described below and which will form the subject matter of the claims appended hereto.

In this respect, before explaining at least one aspect of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

### BRIEF DESCRIPTION OF THE DRAWINGS

FIG. 1 is a schematic diagram illustrating an exemplary wire harness according to aspects of the invention.

FIG. 2 is a partial side view of a wire with protective layers of metal and fiberglass in FIG. 1.

FIG. 3 is a cross-sectional side view of a connection portion of a wire end and a terminal member enclosed by an inverted sleeve in FIG. 1.

FIG. 4A is a cross-sectional side view of an inverted sleeve including two folded sleeves.

FIG. 4B is another cross-sectional view of the inverted sleeve of FIG. 4A.

FIG. 5A is a cross-sectional side view of the inner folded sleeve of FIG. 5B.

FIG. 5B is a side view of the inner folded sleeve.

FIG. 6A is a cross-sectional side view of the outer folded sleeve of FIG. 6B.

FIG. 6B is a side view of the outer folded sleeve.

### DETAILED DESCRIPTION OF THE INVENTION

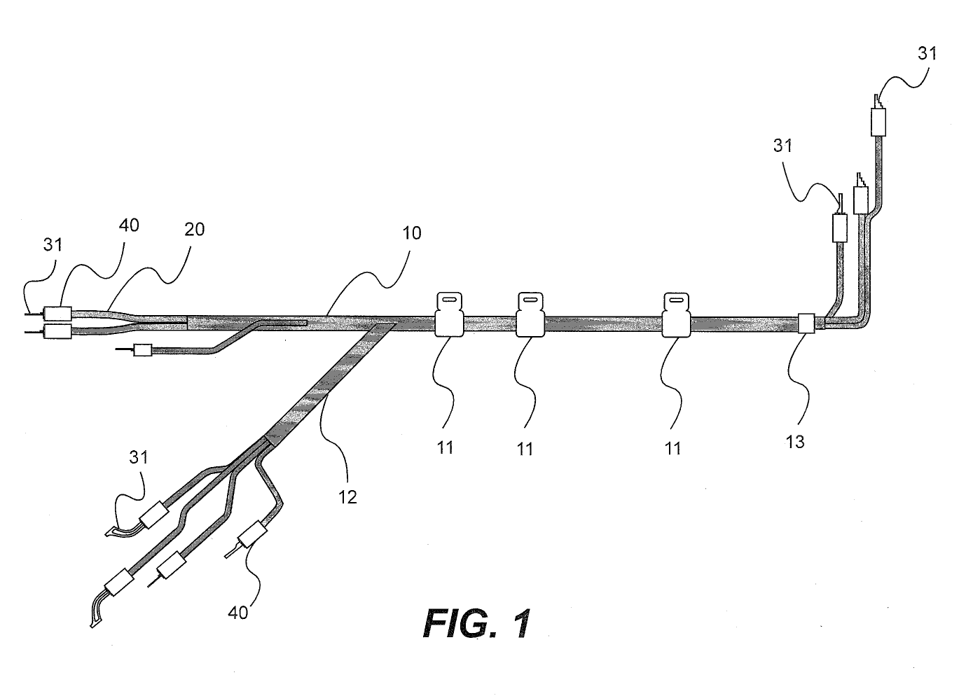

Referring now to the accompanying drawings, a detailed description will be given of an aspect of the invention. FIG. 1 illustrates an exemplary wire harness according to aspects of the invention. The wire harness includes a plurality of wires. As shown in FIG. 1, the wire harness can include a main trunk 10 containing the plurality of wires. To secure the main trunk 10 and the plurality of the wires thereof, the main trunk 10 can be clamped by multiple mounting clips 11 and the main trunk can optionally be secured by a protective band 13. Optionally, the main trunk can have a branch 12 which also may contain a plurality of wires. It should be apparent from FIG. 1 that the main trunk 10 can have a plurality of branches where each branch can contain a plurality of wires. The plurality of wires may include a wire with protective layers of metal and fiberglass 20. In various aspects, all the plurality of wires may be wires with protective layers of metal and fiberglass. In various aspects, a protective sheath can optionally be provided to enclose the main truck and/or the corresponding branches. Each wire end may be enclosed by a metal stiffener and a sleeve 40 which receives one end of a corresponding terminal member 31. In some aspects, a connection portion between the wire end and the terminal member may be enclosed in the metal stiffener and the sleeve 40. In some aspects, the connection portion may include a point where the wire end is physically and electrically connected to the terminal member 31. Optionally, the connection portion may include a junction between a conductive core of the wire 20 and metal of the terminal member 31.

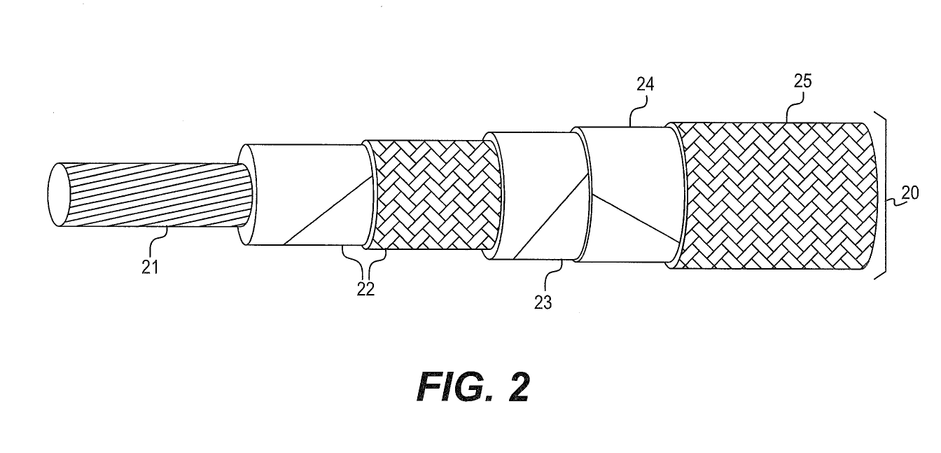

FIG. 2 shows a partial side view of a wire with protective layers of metal and fiberglass 20. The wire according to the invention provides heat resistance as well as moisture protection. As shown in FIG. 2, the wire may include a conductive core and a plurality of protective layers. One or more insulation layers 22 provided may surround a conductor core 21 made of a conducting material. The conductor core 21 may include any conducting materials. In some aspects, the conductor core may include copper based conducting materials. Optionally, the conductor core may include 27% nickel-clad copper. However, the insulation may also be applied to fiber optic wires as well. The insulation layers 22 surrounding the conductor core 21 may be heat-resistant. In some aspects, the insulation layers 22 may include a Mica tape and TFE (tetrafluoroethylene) treated glass braid. The Mica tape may include a complex aluminum silicate which contains a certain amount of magnesium. The insulation layers 22 may be closed by a heat barrier 23. The heat barrier 23 may include a Mica tape. Unlike a conventional wire with protective layers of metal and fiberglass, the wire with protective layers of metal and fiberglass 20 may include one or more moisture barriers 24. Because the protective layers of metal and fiberglass generally have a porous surface structure, the protective layers do not provide good protection against moisture. Thus, the one or more moisture barriers 24 provided enhance protection against moisture. The moisture barrier 24 may include a thermoplastic material, optionally a TFE (tetrafluoroethylene) tape. In some aspects, the moisture barrier 24 may include a skived Teflon tape. The outermost layer 25 covering the moisture barrier 24 may include TFE (tetrafluoroethylene) treated glass braid. In various aspects, it is also possible to change the sequence of protective layers, depending on the kinds of protective layers. In some aspects, the wire with protective layers of metal and fiberglass 20 may include a FG2000® cable available from CABLE USA LLC.

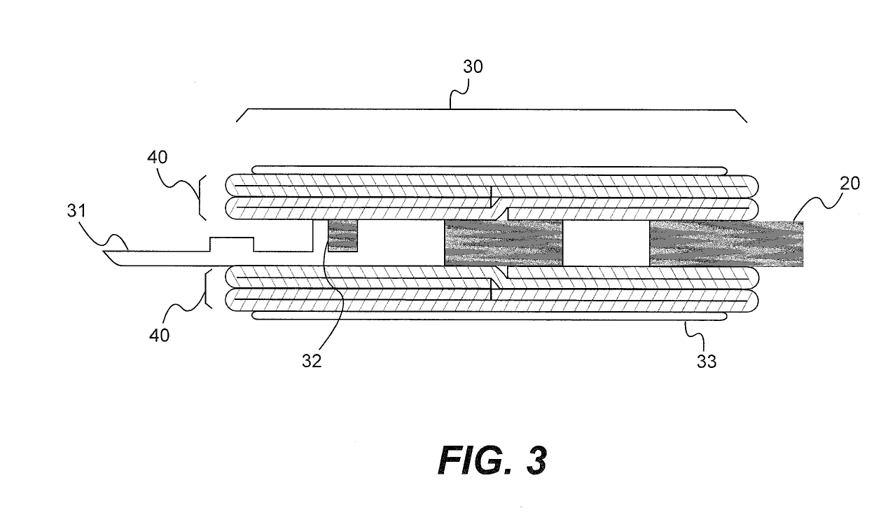

Each end of the wires with protective layers of metal and fiberglass in FIG. 1 may be enclosed by a sleeve, preferably, an inverted sleeve 40. FIG. 3 shows a cross-sectional side view of a connection portion 30 between a wire 20 and a terminal member 31 enclosed by the inverted sleeve 40. In some aspects, it is also possible that an inverted sleeve 40 may contain one or more sleeves. The terminal member 31 may include a terminal lug, i.e. a ring terminal. The connection portion 30 may include a junction 32 where the wire end is physically and electrically connected to an end of the terminal member. In some aspects, the connection portion 30 may include a junction between a conductive core of the wire and metal of the terminal member. In various aspects, an inverted sleeve 40 may be placed over a wire 20 and a terminal member 31 to enclose the connection portion 30, and bent to be firmly held. When a wire end is connected to a terminal member 31, the conductive core of the wire and metal braid can be exposed to the surrounding environment at a junction where the conductive core of the wire is physically and electrically connected to the terminal member. If there is moisture present in the environment, an electrical short can occur at the junction, thereby affecting aircraft operations. By enclosing the junction with an inverted sleeve 40, the junction can be protected from the surrounding environment containing moisture or any other contaminants. Optionally, the inverted sleeve 40 may be wrapped by a protective layer 33.

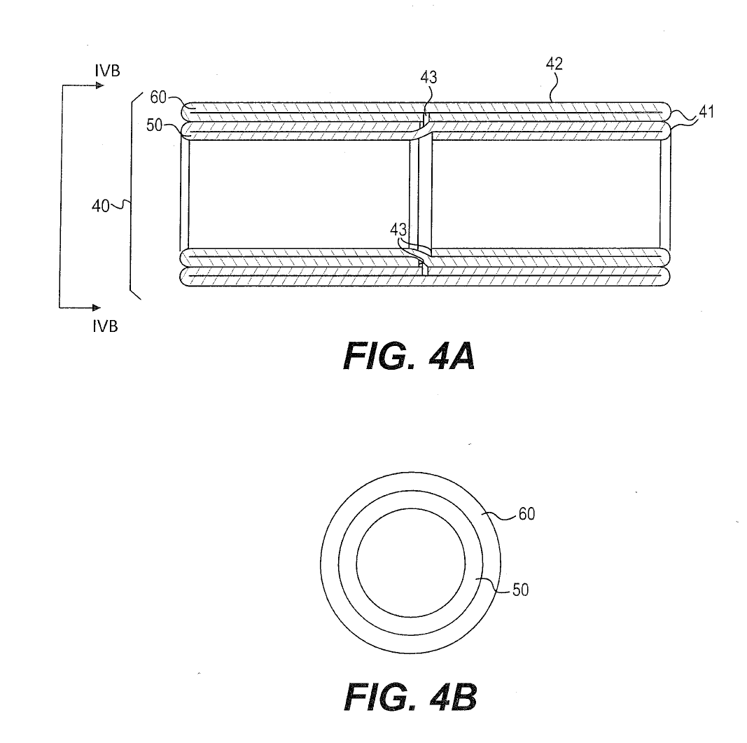

FIG. 4A shows a cross-sectional side view of the inverted sleeve 40. The inverted sleeve may have folds 41 at its ends. The inverted sleeve may have a multi-layer wall. In some aspects, the inverted sleeve may have a quad-layer wall 42 as shown in FIG. 4A. The inverted wall having a quad layer wall 42 may be obtained by combining two double layer folded sleeves, 50, 60. The inner folded sleeve 50 may have a double layer wall, and so does the outer folded sleeve 60. Another cross-sectional view (IVB) is shown in FIG. 4B. Because the inner folded sleeve 50 is encompassed by the outer folded sleeve 60, the sleeve 50 is smaller in diameter than the counterpart 60 as shown in FIG. 4B. The ends of the inverted sleeve 40 have folds 41 and do not have exposed frayed edges 43 of the sleeves as the frayed edges 43 are hidden inside the inverted sleeve 40 and thus are not exposed to the surrounding atmosphere of the inverted sleeve 40. Optionally, the inverted sleeve 40 may be wrapped by a protective layer 33.

The inverted sleeve 40 of the invention provides many advantages. The wall of inverted sleeve can have a multi-layered structure. Moisture penetration through the wall can be limited, depending on the materials of the inverted sleeve. However, the multi-layered structure of the inverted sleeve can deter moisture penetration by the increased wall thickness. It is also possible to vary the wall thickness of an inverted sleeve by combining one or more folded sleeves. Additionally, by placing the frayed edges 43 inside the inverted sleeve 40 and thereby preventing them from being exposed to the surrounding atmosphere of the inverted sleeve, moisture penetration through the frayed edges 43 can be prevented or limited. This structural design of the inverted sleeve 40 is advantageous particularly when a sleeve contains porous materials which make the frayed edges of the sleeve more susceptible to moisture penetration. The outer surface of inverted sleeve 40 has no exposed frayed edges, thereby not exposing frayed edges of sleeve to the surrounding atmosphere.

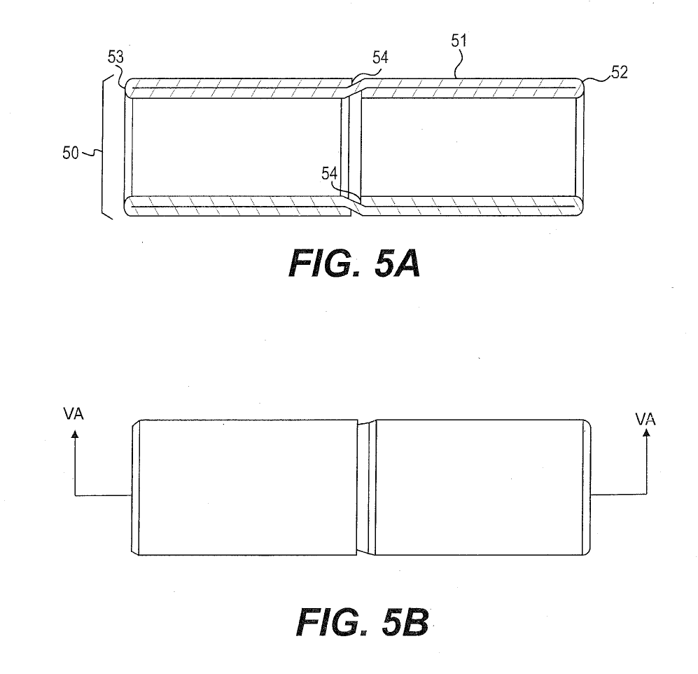

FIG. 5B shows a cross-sectional side view of the inner folded sleeve 50 in FIG. 4. FIG. 5B shows a side view (VA) of the inner folded sleeve 50 having a tubular shape 50. The inner folded sleeve 50 has a double layer wall 51 and has folds, 52, 53 at its ends. The inner folder 50 may be obtained by folding one end of a sleeve inwardly 52 and folding the other end outwardly 53. The folded sleeve 50 now has folds 52, 53 but does not have frayed edges 54 at its ends.

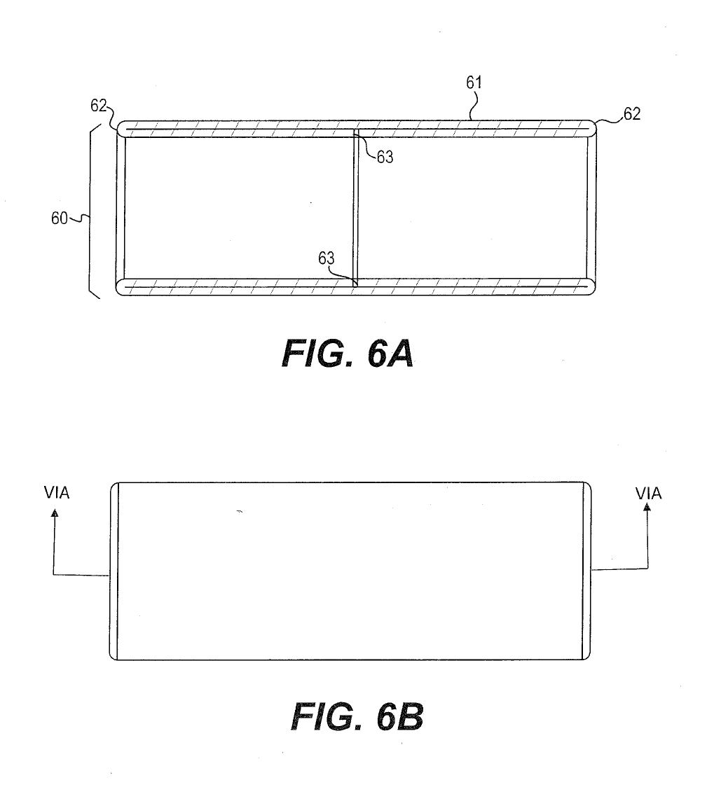

FIG. 6A shows a cross-sectional side view of the outer folded sleeve 60. FIG. 6B shows a side view (VIA) of the outer folded sleeve 60 having a tubular shape. Similar to the inner folded sleeve 50, the outer folded sleeve 60 has a double layer wall 61 and has folds 62 at its ends where the folded sleeve 60 is larger in diameter compared to its counterpart 50. However, unlike the inner folded sleeve 50, the folded sleeve 60 has a fold 62 bent inwardly at each of the ends and thus the outer surface is a continuous surface with frayed edges hidden and not exposed 63.

As shown in FIG. 4A, by encompassing the inner folded sleeve 50 with the outer folded sleeve 60 to obtain a final inverted sleeve, the obtained inverted sleeve 40 has a quad layer wall and has folds at its ends. Additionally, the outer surface of the inverted sleeve 40 including the sides has no frayed edges exposed to its surrounding atmosphere. Although the inverted sleeve 40 has a quad layer wall, it should be apparent that the wall thickness of an inverted sleeve can vary, depending on a combination of folded sleeves.

Once the folded sleeves are fabricated, in some aspects, the folded sleeves may be soaked in a bath of high temperature moisture resistant sealant prior to being placed over a wire end. In addition to the structural advantages of the inverted sleeve, the high temperature moisture resistant sealant enhances the overall moisture protection of an inverted sleeve made of the folded sleeves. In some aspects, the high temperature moisture resistant sealant may include one or more of silicone, catalyzed silicone, glass composite, and the like. In various aspects, the high temperature moisture resistant sealant may include a Duraseal™ 1529 series high temperature moisture resistant sealant. While the soaked sleeves are wet, the wet sleeves are placed over the connection portion 30 between a wire 20 and a terminal member 31 as shown in FIG. 3. The wet sleeves are optionally bent to be firmly held at the connection portion 30. Subsequently, the whole wire end including the inverted sleeve 40 is cured. In some aspects, the protective layer 33 may include the high temperature moisture sealant. Alternatively, the protective layer 33 may be placed on a coated layer of the high temperature moisture sealant of the inverted sleeve 40.

An engine system equipped with the wire harness of the invention provides excellent moisture protection, while utilizing the advantages that a wire with protective layers of metal and fiberglass provides. A turbine engine typically includes a compressor, a combustor, a turbine, and a nozzle including an engine starting system. The wire harness according to the invention enhances protection against moisture that can penetrate throughout the turbine engine components.

Additionally, the engine system may include a terminal (stud) connected to a sensor unit in the engine. The terminal includes a threaded terminal, a cage and an electrical insulator. When the insulator is porous, the terminal can be susceptible to moisture penetration. Thus, applying the high temperature moisture resistant sealant to the terminal can further improve protection against moisture in the engine system. In some aspects, the terminal may be coated with the high temperature moisture resistant sealant. Optionally, the insulator may be coated with the high temperature moisture resistant sealant.

Although specific exemplary aspects of the invention have been described, internal and external components and configurations may be implemented in reverse to provide the same benefits provided by the inventive aspects described. In addition, it will be appreciated by one skilled in the art that other related items can be incorporated and used along with aspects derived from the invention.

The many features and advantages of the invention are apparent from the detailed specification, and thus, it is intended by the appended claims to case all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A wire harness, comprising:
a plurality of wires, wherein the plurality of wires comprise one or more wires with protective layers of metal and fiberglass;
a terminal member, wherein the terminal member is connected to one of the plurality of wires;
an inverted sleeve, wherein the inverted sleeve is placed on one of the plurality of wires;
and a high temperature moisture resistant sealant.

2. The wire harness according to claim 1, wherein the one or more wires with the protective layers of metal and fiberglass comprise one or more moisture barriers.

3. The wire harness according to claim 1, wherein the inverted sleeve is coated with the high temperature moisture resistant sealant.

4. The wire harness according to claim 1, wherein the inverted sleeve encloses a junction between a wire end and the terminal member wherein the wire end is an end of the one or more wires with the protective layers of metal and fiberglass.

5. The wire harness according to claim 1, wherein the inverted sleeve does not have frayed edges at ends of the inverted sleeve.

6. The wire harness according to claim 1, wherein at least one wire of the one or more wires with the protective layers of metal and fiberglass comprises:
a conductor core;
insulation layers comprising a Mica tape and TFE (tetrafluoroethylene) treated glass braid;
a heat barrier having a Mica tape;
a moisture barrier having a TFE (tetrafluoroethylene) tape; and
an outermost layer having TFE (tetrafluoroethylene) treated glass braid.

7. The wire harness according to claim 1, wherein the inverted sleeve comprises one or more folded sleeves, wherein the folded sleeves are coated with the high temperature moisture resistant sealant.

8. The wire harness according to claim 1, wherein the inverted sleeve has a quad layer wall.

9. The wire harness according to claim 1, wherein a junction between the one or more wires with the protective layers of metal and fiberglass and the terminal member is coated with the high temperature moisture resistant sealant.

10. The wire harness according to claim 1, further comprising a terminal lug,
wherein the high temperature moisture resistant sealant is disposed on an end of the terminal lug to provide a non-hygroscopic barrier to moisture ingress at a point where a conductor of the one or more wires with the protective layers of metal fiber glass is terminated into the terminal lug.

11. The wire harness according to claim 1, wherein the high temperature moisture resistance sealant comprises one or more of silicone, catalyzed silicone, and glass composite.

12. A method for manufacturing a wire harness, comprising:
forming a main trunk comprising a plurality of wires wherein the plurality of wires comprises one or more wires with protective layers of metal and fiberglass;
connecting a wire end of the one or more wires with the protective layers of metal and fiberglass with a terminal member;
applying a high temperature moisture resistant sealant to an inverted sleeve; and
enclosing a junction with the wire end and the terminal member with an inverted sleeve.

13. The method according to claim 12, wherein at least one of the one or more wires with the protective layers of metal and fiberglass comprises:
a conductor core;
insulation layers comprising a Mica tape and TFE (tetrafluoroethylene) treated glass braid;
a heat barrier having a Mica tape;
a moisture barrier having a TFE (tetrafluoroethylene) tape; and
an outermost layer having TFE (tetrafluoroethylene) treated glass braid.

14. The method according to claim 12, further comprising:
folding ends having frayed edges of a sleeve to form an inverted sleeve,
wherein the inverted sleeve comprises folds at ends of the inverted sleeve and the ends of the inverted sleeve do not have the frayed edges.

15. The method according to claim 12, further comprising:
wetting the inverted sleeve with the high temperature moisture resistant sealant prior to being placed over the wire end;
placing the wet sleeve over the wire end; and
subsequently curing the wire end and the inverted sleeve.

16. The method according to claim 12, further comprising:
wetting the inverted sleeve with the high temperature moisture resistant sealant prior to being placed over the wire end;
placing the wet sleeve over the wire end;
bending the wet sleeve to be firmly held at a desired location; and
subsequently curing the wire end and the inverted sleeve.

17. The method according to claim 12, further comprising:
disposing the high temperature moisture resistant sealant on at least one end of a terminal member to provide a non-hygroscopic barrier to moisture ingress at a point where a conductor of the one or more wires with the protective layers of metal fiber glass is terminated into the terminal member.

18. The method according to claim 12, wherein the high temperature moisture resistance sealant comprises one or more of silicone, catalyzed silicone, and glass composite.

19. A turbine engine system comprising the wire harness according to claim 1.

20. The turbine engine system according to claim 19, further comprising a terminal, wherein the terminal is coated with the high temperature moisture resistant sealant.
